(19) United States
(12) Patent Application Publication
(10) Pub. No.: US 2026/0267043 A1
(43) Pub. Date: Sep. 10, 2026

(54) OPTICAL SENSOR SYSTEM

(71) Applicant: FUJIFILM Corporation, Tokyo (JP)

(72) Inventor: Yujiro YANAI, Minamiashigara-shi (JP)

(73) Assignee: FUJIFILM Corporation, Tokyo (JP)

(21) Appl. No.: 19/661,686

(22) Filed: Apr. 29, 2026

Related U.S. Application Data
(63) Continuation of application No. PCT/JP2024/038476, filed on Oct. 29, 2024.

(30) Foreign Application Priority Data
Nov. 2, 2023 (JP) 2023-188312

(51) Int. Cl. G02B 5/18; G01J 1/04

(52) U.S. Cl. CPC G02B 5/1828; G01J 1/0448

(57) ABSTRACT

An object of the present invention is to provide an optical sensor system that can be miniaturized, thinned, and improved in designability by using one opening portion, using an optical element that separates wavelengths of an incident ray to guide only a specific wavelength, and causing each sensor to sense the guided light. The object is achieved by an optical sensor system including at least a light guide substrate, a diffraction element 1 that separates incident ray into rays of at least two wavelengths, a diffraction element 2 that diffracts the rays separated by the diffraction element 1, and a plurality of sensors that respectively sense a plurality of rays separated by the diffraction element 1.

### CROSS-REFERENCE TO RELATED APPLICATIONS

This application is a Continuation of PCT International Application No. PCT/JP2024/038476 filed on Oct. 29, 2024, which claims priority under 35 U.S.C. § 119(a) to Japanese Patent Application No. 2023-188312 filed on Nov. 2, 2023. The above applications are hereby expressly incorporated by reference, in their entirety, into the present application.

### BACKGROUND OF THE INVENTION

### 1. Field of the Invention

The present invention relates to an optical sensor system. In particular, the present invention relates to a sensor configuration capable of achieving miniaturization, thinning, and enhancement of designability.

### 2. Description of the Related Art

In recent years, sensing techniques utilizing wavelength characteristics of transmittance, reflectance, and absorbance of various substances have started to be used.

For example, as represented by face authentication of a smartphone or the like, accuracy of face authentication is improved by collecting three-dimensional information of a face using near-infrared light in addition to a camera image in a normal visible light region.

In addition, examples of the vital sensing include a sensor that measures a blood oxygen saturation (SpO₂) using wavelengths in a visible light region and a near-infrared light region.

In these sensor systems, a sensor corresponding to each wavelength (including a two-dimensional sensor) and an opening portion having a lens for taking in light into each sensor are disposed. Therefore, a plurality of opening portions are required in the apparatus, and a space for disposing these members is required. In addition, in these sensor systems, light of other wavelengths may be noise. Therefore, a band pass filter or the like may be disposed in front of the sensor to measure only a specific wavelength.

On the other hand, JP2020-22121A discloses, as a sensor system that individually detects a plurality of rays of different wavelength ranges, a sensor system (imaging apparatus) comprising a separation unit that separates incident ray into rays of two or more wavelength ranges and a detection unit that detects the separated rays of the two or more wavelength ranges and outputs a signal from which a wavelength can be extracted in a tunable manner in a post-process.

In this sensor system, an optical member including a separation surface that separates incident ray into rays of two or more wavelength ranges and is disposed a separation surface to have a predetermined angle with respect to an optical axis of the incident ray is exemplified as the separation unit. Specifically, a dichroic filter that separates incident ray into reflected light and transmitted light by a separation surface is exemplified as the separation unit.

According to the sensor system disclosed in JP2020-22121A, one opening portion having a lens for taking in light into each sensor may be provided.

However, in this apparatus, it is necessary to dispose a separation unit such as a dichroic filter to be inclined with respect to the optical axis of the incident ray, and thus a space for this purpose is required. In addition, the ray separated by the dichroic filter travels in different directions at, for example, an angle of 90° and is incident into the corresponding sensor. Therefore, it is necessary to secure an optical path of each ray traveling in different directions, and a space for this purpose is required.

### SUMMARY OF THE INVENTION

In view of the above, an object of the present invention is to provide an optical sensor system that can be miniaturized, thinned, and improved in designability by using one opening portion, using an optical element that separates wavelengths of an incident ray to guide only a specific wavelength, and causing each sensor to sense the guided light.
[1]

An optical sensor system comprising at least:
a light guide substrate;
a diffraction element 1 that separates incident ray into rays of at least two wavelengths;
a diffraction element 2 that diffracts the rays separated by the diffraction element 1; and
a plurality of sensors that respectively sense a plurality of rays separated by the diffraction element 1.
[2]

The optical sensor system according to [1],
in which the diffraction element 1 separates the incident ray into a ray of a wavelength in a visible light region and a ray of a wavelength in a short-wave infrared region.
[3]

The optical sensor system according to [1],
in which the diffraction element 1 separates the incident ray into a ray of a wavelength in a visible light region, a ray of a wavelength in a near-infrared light region, and a ray of a wavelength in a short-wave infrared region.
[4]

The optical sensor system according to any one of [1] to [3],
in which either one of the diffraction element 1 and the diffraction element 2, or both of the diffraction element 1 and the diffraction element 2, are liquid crystal diffraction elements.

According to the present invention, it is possible to provide a sensor system that is miniaturized, thinned, and improved in designability.

### BRIEF DESCRIPTION OF THE DRAWINGS

FIG. 1 is a diagram schematically showing an example of an optical sensor system according to the present invention.

FIG. 2 is a diagram schematically showing an example of an action of separating a ray in the optical sensor system of FIG. 1.

FIG. 3 is a diagram schematically showing another example of the optical sensor system according to the present invention.

FIG. 4 is a diagram schematically showing another example of the optical sensor system according to the present invention.

FIG. 5 is a diagram schematically showing another example of the optical sensor system according to the present invention.

FIG. 6 is a schematic diagram showing an example of a reflective type liquid crystal diffraction element.

FIG. 7 is a schematic diagram showing an example of a reflective type liquid crystal diffraction element.

FIG. 8 is a schematic diagram showing an action of an example of a reflective type liquid crystal diffraction element.

FIG. 9 is a schematic diagram showing an example of a transmissive type liquid crystal diffraction element.

FIG. 10 is a schematic diagram showing an example of a transmissive type liquid crystal diffraction element.

FIG. 11 is a schematic diagram showing an action of an example of a transmissive type liquid crystal diffraction element.

FIG. 12 is a schematic diagram showing an action of an example of a transmissive type liquid crystal diffraction element.

### DESCRIPTION OF THE PREFERRED EMBODIMENTS

Hereinafter, an optical sensor system according to an embodiment of the present invention will be described in detail based on suitable embodiments shown in the drawings.

In the present specification, numerical ranges represented by “to” include numerical values before and after “to” as lower limit values and upper limit values.

In addition, in the present specification, visible light (light having a wavelength in a visible light region) is light having a wavelength (wavelength range) of 380 to 800 nm, near-infrared light (NIR) is light having a wavelength of more than 800 nm and 1,000 nm or less, and short-wave infrared light (SWIR; light having a wavelength in a short-wave infrared region) is light having a wavelength of more than 1,000 nm and 2,500 nm or less.

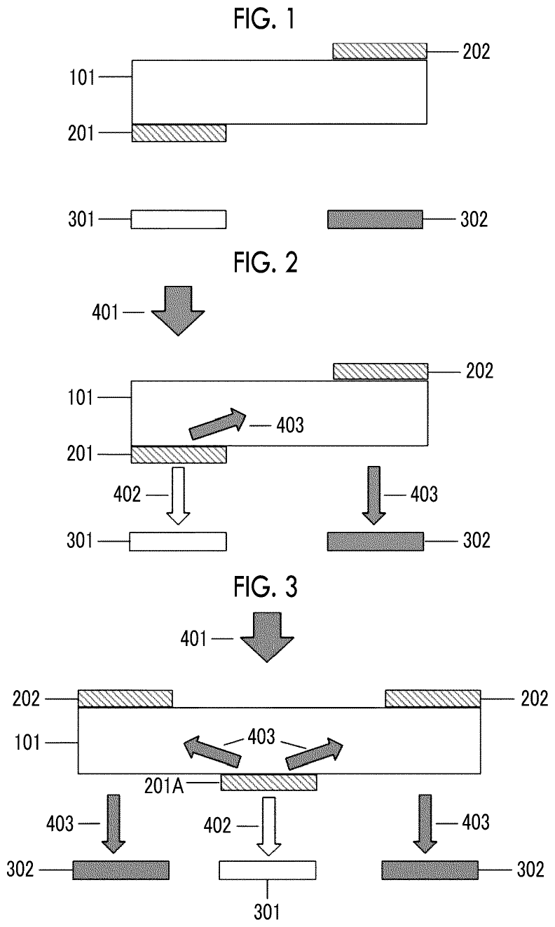

FIG. 1 schematically shows an example of an optical sensor system according to the embodiment of the present invention.

The optical sensor system shown in FIG. 1 includes a light guide substrate 101, a first diffraction element 201, a second diffraction element 202, a first sensor 301, and a second sensor 302.

In the example shown in the drawing, the first diffraction element 201 is bonded to one surface (upper surface in the drawing) of the light guide substrate 101, and the second diffraction element 202 is bonded to the other surface (lower surface in the drawing) of the light guide substrate 101.

In the present example, a surface on which the second diffraction element 202 is disposed is an incident surface of the light guide substrate 101.

The light guide substrate 101 is a well-known light guide element (light guide plate) used as a light guide plate or the like in a backlight unit of a liquid crystal display device.

The first diffraction element 201 is a diffraction element 1 according to the embodiment of the present invention. Accordingly, the first diffraction element 201 is a diffraction element that separates incident ray into rays of at least two wavelengths.

In the example shown in the drawing, the first diffraction element 201 is, for example, a reflective type diffraction element that selectively reflects short-wave infrared light (SWIR light) and transmits other light components. As a result, the first diffraction element 201 separates incident ray into SWIR light and light other than the SWIR light.

In addition, in the example shown in the drawing, the first diffraction element 201 diffracts and reflects the SWIR light in the right direction toward the incidence side of the light. That is, in the example shown in the drawing, the first diffraction element 201 diffracts and reflects the SWIR light in the right direction in the drawing.

The second diffraction element 202 is a diffraction element 2 according to the embodiment of the present invention. Accordingly, the second diffraction element 202 is a diffraction element that diffracts the light separated by the first diffraction element 201 which is the diffraction element 1. Accordingly, the second diffraction element 202 is provided at a position where the SWIR light diffracted and reflected by the first diffraction element 201 is incident.

In the example shown in the drawing, the second diffraction element 202 is, for example, the same diffraction element as the first diffraction element 201. Accordingly, the second diffraction element 202 also diffracts and reflects the SWIR light in the right direction toward the incidence side of the light.

In FIG. 1, the first diffraction element 201 and the second diffraction element 202 are vertically inverted. Accordingly, the second diffraction element 202 diffracts and reflects the SWIR light of dextrorotatory circularly polarized light separated by the first diffraction element 201 that selectively reflects the light in the left direction in the drawing.

The second diffraction element 202 is not limited to a diffraction element that selectively diffracts and reflects light in a specific wavelength range such as SWIR light. For example, the second diffraction element 202 may diffract and reflect light in a wide wavelength range from visible light to SWIR light.

However, in consideration of the efficiency of diffraction and reflection of light, it is preferable that the second diffraction element 202 selectively diffracts and reflects light having a specific wavelength (wavelength range) such as SWIR light, NIR light, red light, green light, and blue light, as in the first diffraction element 201.

Regarding this point, the same applies to a diffraction element 204 described below.

In the optical sensor system according to the embodiment of the present invention, the diffraction element 1 is not limited to separating SWIR light and light having other wavelengths. That is, in the present invention, the light separated by the diffraction element 1 is not limited.

For example, the diffraction element 1 may separate incident ray into light having any wavelength (wavelength range) of near-infrared light (NIR light), infrared light in a predetermined wavelength range exceeding SWIR light, red light, green light, blue light, and light in the entire visible light region, and other light.

Alternatively, the diffraction element 1 may separate incident ray into two rays having predetermined wavelengths, for example, separate incident ray into NIR light and SWIR light.

Further, in the optical sensor system according to the embodiment of the present invention, the diffraction element 1 may separate incident ray into three or more rays having different wavelengths.

In addition, in the optical sensor system in the example shown in the drawing, the diffraction element 1 (first diffraction element 201) selectively reflects light having a predetermined wavelength such as SWIR light and transmits other light. However, the present invention is not limited to this.

That is, in the optical sensor system according to the embodiment of the present invention, the diffraction element 1 may selectively transmit light having a predetermined wavelength and reflect other light. Alternatively, in the optical sensor system according to the embodiment of the present invention, the diffraction element 1 may selectively reflect light in a predetermined wavelength range, selectively transmit light in the predetermined wavelength range, and absorb light in other wavelength ranges.

In the optical sensor system according to the embodiment of the present invention, the sensor performs photometry (sensing) on each of a plurality of rays separated by the diffraction element 1.

In the optical sensor system shown in FIG. 1, the first sensor 301 performs photometry on light transmitted through the first diffraction element 201. On the other hand, the second sensor 302 performs photometry on SWIR light selectively reflected by the first diffraction element 201.

Accordingly, the first sensor 301 is disposed at a position where light transmitted through the light guide substrate 101 and the first diffraction element 201 can be incident. In addition, the second sensor 302 is disposed at a position where SWIR light reflected by the second diffraction element 202 and emitted from the light guide substrate 101 can be incident.

FIG. 2 schematically shows an example of an action of separating light in the optical sensor system shown in FIG. 1.

In the present example, as an example, incident ray 401 in which visible light 402 and SWIR light 403 are mixed is incident on the optical sensor system.

As an example, the incident ray 401 is incident on the optical sensor system from a normal direction of the light guide substrate 101 toward a position corresponding to the first diffraction element 201.

The incident ray 401 incident on the optical sensor system is transmitted through the light guide substrate 101 and is incident on the first diffraction element 201. As described above, the first diffraction element 201 selectively reflects SWIR light and transmits the other light. Accordingly, the incident ray 401 is divided into visible light 402, which is transmitted light, and SWIR light 403, which is reflected light, by the first diffraction element 201.

The visible light 402 transmitted through the first diffraction element 201 is incident on the first sensor 301 and is sensed (photometrically measured).

In addition, as described above, the first diffraction element 201 is a reflective type diffraction element that diffracts and reflects SWIR light in a right direction in the drawing. Accordingly, the SWIR light 403 diffracted and reflected by the first diffraction element 201 is guided in the light guide substrate 101 and is incident on the second diffraction element 202. The SWIR light 403 incident on the second diffraction element 202 is diffracted in a left direction in the drawing by the second diffraction element 202, is reflected by changing the direction of light to a direction of the second sensor 302, is emitted from the light guide substrate 101, and is sensed by the second sensor 302.

FIG. 3 schematically shows another example of the optical sensor system according to the embodiment of the present invention.

The optical sensor system according to the embodiment of the present invention shown below includes a plurality of the same members as the optical sensor system shown in FIGS. 1 and 2, and thus, the same members are denoted by the same reference numerals, and the description will be mainly made for different parts.

In the optical sensor system shown in FIG. 3, a first diffraction element 201A, which is the diffraction element 1 according to the embodiment of the present invention, is bonded to the center of one surface (lower surface in the drawing) of the light guide substrate 101 in the longitudinal direction. In addition, the second diffraction element 202 is disposed at both end portions of the other surface (upper surface in the drawing) of the light guide substrate 101 in the longitudinal direction. The second diffraction element 202 is the optical element 2 according to the embodiment of the present invention as described above.

In the present example, the surface on which the second diffraction element 202 is disposed is the light incident surface in the light guide substrate 101.

As in the example shown in FIGS. 1 and 2, the first diffraction element 201A, which is the diffraction element 1 according to the embodiment of the present invention, is a reflective type diffraction element that selectively reflects the SWIR light and transmits light having other wavelengths. Here, in the example shown in FIG. 3, the first diffraction element 201A separates and reflects the SWIR light in two different directions.

As in the above-described example, both of the two second diffraction elements 202 are provided at positions where the SWIR light diffracted and reflected by the first diffraction element 201A is incident.

In the present example, as an example, the second diffraction element 202 is the same as the first diffraction element 201A. However, the present invention is not limited to this, and both of the two second diffraction elements 202 may diffract and reflect the incident SWIR light only in one direction toward the corresponding second sensor 302.

Further, as in the above-described example, the first sensor 301 is disposed at a position where the light transmitted through the first diffraction element 201A and emitted from the light guide substrate 101 can be incident. In addition, the two second sensors 302 are disposed at positions where the SWIR light reflected by the corresponding second diffraction element 202 and emitted from the light guide substrate 101 can be incident.

As an example, in the optical sensor system shown in FIG. 3, the incident ray 401 in which the visible light 402 and the SWIR light 403 are mixed is incident on the optical sensor system at a position corresponding to the first diffraction element 201A from the normal direction of the light guide substrate 101. The incident ray 401 is transmitted through the light guide substrate 101 and is incident on the first diffraction element 201A.

As described above, the first diffraction element 201A selectively diffracts and reflects the SWIR light and transmits the other light. Accordingly, the incident ray 401 is divided into the visible light 402, which is the transmitted light, and the SWIR light 403, which is the reflected light, by the first diffraction element 201A.

The visible light 402 transmitted through the first diffraction element 201A is incident on the first sensor 301 and is sensed.

Here, in the example shown in FIG. 3, the first diffraction element 201A separates and reflects the SWIR light 403 in two different directions. In the present example, the first diffraction element 201A diffracts and reflects the SWIR light in the right direction and the left direction in the drawing.

Accordingly, the SWIR light diffracted in the right direction in the drawing is guided in the light guide substrate 101 and is incident on the second diffraction element 202 on the right side in the drawing, and the SWIR light diffracted in the left direction in the drawing is guided in the light guide substrate 101 and is incident on the second diffraction element 202 on the left side in the drawing.

The SWIR light incident on the second diffraction element 202 on the right side in the drawing is diffracted and reflected in the left direction in the drawing (right direction toward the incident ray) by the second diffraction element 202, the direction of the light is changed to the direction of the second sensor 302, the light is emitted from the light guide substrate 101, and the light is sensed by the corresponding second sensor 302.

On the other hand, the SWIR light incident on the second diffraction element 202 on the left side in the drawing is diffracted and reflected in the right direction in the drawing (left direction toward the incident ray) by the second diffraction element 202, the direction of the light is changed to the direction of the second sensor 302, the light is emitted from the light guide substrate 101, and the light is sensed by the corresponding second sensor 302.

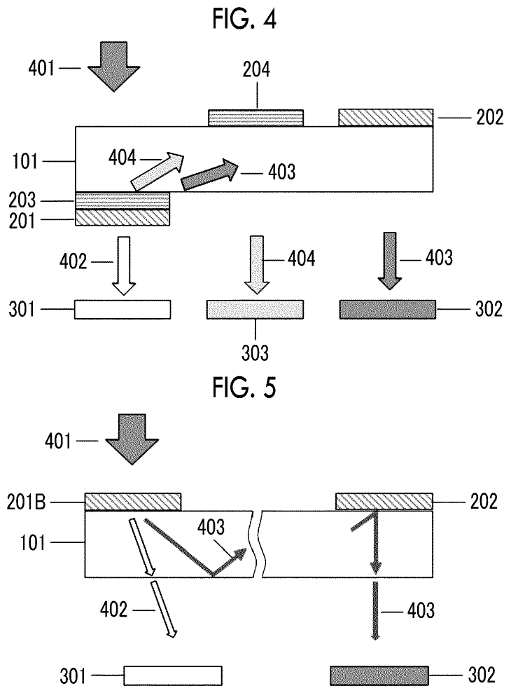

FIG. 4 schematically shows another example of the optical sensor system according to the embodiment of the present invention.

The optical sensor system according to the embodiment of the present invention shown in FIG. 4 is an example of a configuration in which near-infrared light (NIR light) is also separated in addition to the visible light and the SWIR light.

The optical sensor system shown in FIG. 4 has the same basic configuration as the optical sensor system shown in FIGS. 1 and 2.

Specifically, in the optical sensor system shown in FIG. 4, the diffraction element 203 is further laminated on the first diffraction element 201 and is bonded to one surface (lower surface in the drawing) of the light guide substrate 101 in the optical sensor system shown in FIGS. 1 and 2.

In addition, the diffraction element 204 is further bonded to the other surface (upper surface in the drawing) of the light guide substrate 101 between the second diffraction element 202 and the first diffraction element 201 in the longitudinal direction of the light guide substrate 101. Further, the third sensor 303 is disposed at a position corresponding to the reflected light by the diffraction element 204.

In the present example, the surface on which the second diffraction element 202 and the diffraction element 204 are disposed is the light incident surface of the light guide substrate 101.

As described above, the first diffraction element 201 is a reflective type diffraction element that selectively diffracts and reflects the SWIR light. On the other hand, the diffraction element 203 laminated on the first diffraction element 201 is a reflective type diffraction element that selectively diffracts and reflects the NIR light and transmits the other light.

In addition, as in the first diffraction element 201, the diffraction element 203 diffracts and reflects the NIR light in the right direction, that is, in the right direction in the drawing toward the incidence side of light. In the present example, the diffraction angle of the diffraction element 203 is smaller than that of the first diffraction element 201.

On the other hand, the diffraction element 204 diffracts and reflects the NIR light reflected by the diffraction element 203 in the right direction, that is, in the left direction in the drawing toward the incidence side to be incident on the third sensor 303.

Accordingly, the diffraction element 204 is disposed at a position where the NIR light reflected by the diffraction element 203 can be incident. In addition, the third sensor 303 is disposed at a position where the NIR light reflected by the diffraction element 203 and emitted from the light guide substrate 101 can be incident.

In the optical sensor system shown in FIG. 4, the diffraction element 203 is basically the same as the first diffraction element 201, that is, the diffraction element 1 in the present invention, except that the wavelength of light to be selectively reflected is different.

In addition, in the optical sensor system shown in FIG. 4, the diffraction element 204 is basically the same as the second diffraction element 202, that is, the diffraction element 2 in the present invention.

In the optical sensor system shown in FIG. 4, as an example, an incident ray 401 in which visible light, NIR light, and SWIR light are mixed is incident on the optical sensor system at a position corresponding to the first diffraction element 201 from the normal direction of the light guide substrate 101, as in the above-described example.

The incident ray 401 is transmitted through the light guide substrate 101 and is incident on a laminate of the first diffraction element 201 and the diffraction element 203.

The incident ray 401 is first incident on the diffraction element 203. As described above, the diffraction element 203 is a reflective type diffraction element that selectively diffracts and reflects the NIR light and transmits the other light. Accordingly, the incident ray 401 incident on the diffraction element 203 is separated into the NIR light 404 that is reflected light and the visible light 402 and the SWIR light 403 that are transmitted light by the diffraction element 203.

The visible light 402 and the SWIR light 403 transmitted through the diffraction element 203 are then incident on the first diffraction element 201. The first diffraction element 201 selectively diffracts and reflects the SWIR light and transmits the other light. Accordingly, the visible light 402 and the SWIR light 403 incident on the first diffraction element 201 are separated into the SWIR light 403 that is reflected light and the visible light 402 that is transmitted light by the first diffraction element 201.

As a result, the incident ray 401 in which the visible light, the NIR light, and the SWIR light are mixed is separated into the visible light 402, the NIR light 404, and the SWIR light 403 by the laminate of the first diffraction element 201 and the diffraction element 203.

In the present example, the lamination order of the first diffraction element 201 and the diffraction element 203 is not limited to the example shown in the drawing, and may be reversed. Even in a case where the lamination order is reversed, the incident ray 401 can be separated into the visible light 402, the NIR light 404, and the SWIR light 403 by exactly the same operation and effect.

The visible light 402 transmitted through the first diffraction element 201 (laminate) is incident on the first sensor 301 and is sensed.

The NIR light 404 that is diffracted and reflected in the right direction in the drawing by the diffraction element 203 is guided in the light guide substrate 101 and is incident on the diffraction element 204 disposed closer than the second diffraction element 202. As described above, the diffraction angle of the diffraction element 203 is smaller than that of the first diffraction element 201. The NIR light 404 incident on the diffraction element 204 is diffracted and reflected in the left direction in the drawing by the diffraction element 204, and thus the direction of the light is changed to the direction of the third sensor 303, the light is emitted from the light guide substrate 101, and the light is sensed by the third sensor 303.

On the other hand, the SWIR light 403 that is diffracted and reflected in the right direction in the drawing by the first diffraction element 201 is guided in the light guide substrate 101 and is incident on the second diffraction element 202. The SWIR light 403 incident on the second diffraction element 202 is diffracted and reflected in the left direction in the drawing by the second diffraction element 202, and thus the direction of the light is changed to the direction of the second sensor 302, the light is emitted from the light guide substrate 101, and the light is sensed by the second sensor 302.

In the example shown in FIG. 4, the diffraction angle of the diffraction element 203 that selectively diffracts and reflects the NIR light is smaller than that of the first diffraction element 201 that selectively diffracts and reflects the SWIR light. However, the present invention is not limited to this configuration, and the diffraction angle of the diffraction element 203 that selectively diffracts and reflects the NIR light may be larger than that of the first diffraction element 201 that selectively diffracts and reflects the SWIR light.

In all of the examples shown in FIGS. 1 to 4, the light reflected by the diffraction element 1 (first diffraction element 201 (diffraction element 203)) is directly incident on the diffraction element 2 (second diffraction element 202 (diffraction element 204)) without being totally reflected at the interface between the light guide substrate 101 and the air.

However, the optical sensor system according to the embodiment of the present invention is not limited to this configuration. That is, in the present invention, in the aspect in which the reflective type diffraction element 1 is used, the light diffracted and reflected by the diffraction element 1 may be guided by being totally reflected twice or more at the interface between the light guide substrate 101 and the air, and then the light may be incident on the diffraction element 2.

Here, in a case where the diffraction element diffracts and reflects light in accordance with the polarization of the incident ray, such as a reflective type liquid crystal diffraction element described below, in a case where the light is repeatedly totally reflected in the light guide substrate 101, the polarization may be disturbed, and the diffraction and reflection efficiency of the diffraction element 2 may be reduced.

In consideration of this point, in particular, in a case where the diffraction element diffracts and reflects light in accordance with the polarization of the incident ray, such as a reflective type liquid crystal diffraction element, as shown in FIGS. 1 to 4, it is preferable that the light reflected by the diffraction element 1 is directly incident on the diffraction element 2 without being totally reflected at the interface between the light guide substrate 101 and the air.

In all of the optical sensor systems according to the embodiment of the present invention shown in FIGS. 1 to 4, a reflective type diffraction element is used as the diffraction element 1 (first diffraction element 201).

However, the present invention is not limited to this configuration, and the diffraction element 1 may be a transmissive type diffraction element.

In general, in the transmissive type diffraction element, as the wavelength of the incident ray increases, the diffraction angle of the transmitted light increases. For example, in visible light, NIR light, and SWIR light, the diffraction angle of the transmitted light is smallest in the visible light and largest in the SWIR light. Accordingly, in a case where the transmissive type diffraction element is used as the diffraction element 1, the incident ray can be separated into rays of at least two wavelengths by using the transmissive diffraction element. For example, in a case of the transmissive type liquid crystal diffraction element, unlike a case of the reflective type liquid crystal diffraction element formed of a cholesteric liquid crystal, light components having only a specific wavelength cannot be separated, but the diffraction angle of light varies depending on the wavelength, as in the reflective type liquid crystal diffraction element.

Accordingly, by separating the diffraction angle of the light to be separated into light having an angle larger than the Brewster angle of the light guide substrate and light having an angle smaller than the Brewster angle of the light guide substrate, one light component can be emitted from the light guide substrate, and the other light component can be separated into light that travels by being repeatedly totally reflected in the light guide substrate.

FIG. 5 schematically shows an example of the optical sensor system according to the embodiment of the present invention in which the transmissive type diffraction element is used as the diffraction element 1.

In the optical sensor system shown in FIG. 5, a first diffraction element 201B that is the diffraction element 1 is a transmissive type diffraction element. The second diffraction element 202 is the same as that in the above-described example.

As in the above-described example, an incident ray 401 in which visible light and SWIR light are mixed is incident into the first diffraction element 201B from the normal direction of the light guide substrate 101.

As described above, in the visible light and the SWIR light, the diffraction angle of the visible light is small and the diffraction angle of the SWIR light is large in the first diffraction element 201B. Therefore, visible light 402 separated by the first diffraction element 201B is incident into the interface between the light guide substrate 101 and the air at an angle smaller than the Brewster angle of the light guide substrate 101, is emitted from the light guide substrate 101, is incident into the first sensor 301, and is sensed.

On the other hand, SWIR light 403 separated by the first diffraction element 201B at a large diffraction angle is incident into the interface between the light guide substrate 101 and the air at an angle larger than the Brewster angle of the light guide substrate 101 and is totally reflected. The SWIR light 403 that is totally reflected propagates by being repeatedly totally reflected in the light guide substrate 101 and is incident into the second diffraction element 202.

As in the above-described example, the SWIR light 403 incident into the second diffraction element 202 is diffracted in the left direction in the drawing by the second diffraction element 202, the direction of the light is changed to the direction of the second sensor 302, the SWIR light 403 is emitted from the light guide substrate 101, and the SWIR light 403 is sensed by the second sensor 302.

As described above, in the optical sensor system according to the embodiment of the present invention using the light guide substrate, the diffraction element 1 that separates the incident ray into rays of at least two wavelengths, and the diffraction element 2 that diffracts the light separated by the diffraction element 1, as shown in FIGS. 1 to 5, a member that is disposed to be tilted with respect to the incident ray is not required, and the optical path of the light separated according to the wavelength can be formed by the light guide substrate.

As a result, the optical sensor system can be miniaturized and thinned. In addition, by thinning the optical sensor system, the degree of freedom in the design of the system can be improved, and as a result, the designability of the system can be improved.

In the optical sensor system according to the embodiment of the present invention described above, the visible light, the SWIR light, or further the NIR light is separated and detected, but the present invention is not limited thereto.

That is, in the present invention, the light to be detected, that is, the light separated by the diffraction element 1 is not limited to the light having each of the above-described wavelengths (wavelength ranges), and may be, for example, infrared light in a predetermined wavelength range exceeding the SWIR light, red light, green light, blue light, or the like. Among these, the SWIR light and the NIR light are suitable as the detection target.

In the optical sensor system according to the embodiment of the present invention, the diffraction element is not limited, and various known diffraction elements can be used.

Examples of the diffraction element include a surface relief type diffraction element, a volume hologram type diffraction element, and a liquid crystal diffraction element. Among these, a liquid crystal diffraction element that can maintain a high diffraction efficiency without depending on the magnitude of the diffraction angle is preferable.

The liquid crystal diffraction element may be a transmissive type or a reflective type, and may be appropriately selected from the viewpoint of the configuration, the disposition, the restriction, and the like.

The diffraction angle, the diffraction efficiency, and the diffraction wavelength of the diffraction by the liquid crystal diffraction element can be appropriately adjusted according to the use application. The diffraction angle depends on the in-plane pitch (diffraction period (single period Λ)), and the diffraction efficiency depends on the film thickness. The diffraction wavelength depends on the film thickness in the case of the transmissive type and depends on the chiral pitch length in the case of the reflective type. Therefore, the diffraction wavelength may be appropriately adjusted according to the use application.

In addition, the liquid crystal diffraction element may be used by laminating or bonding elements that diffract different wavelengths to overlap the elements.

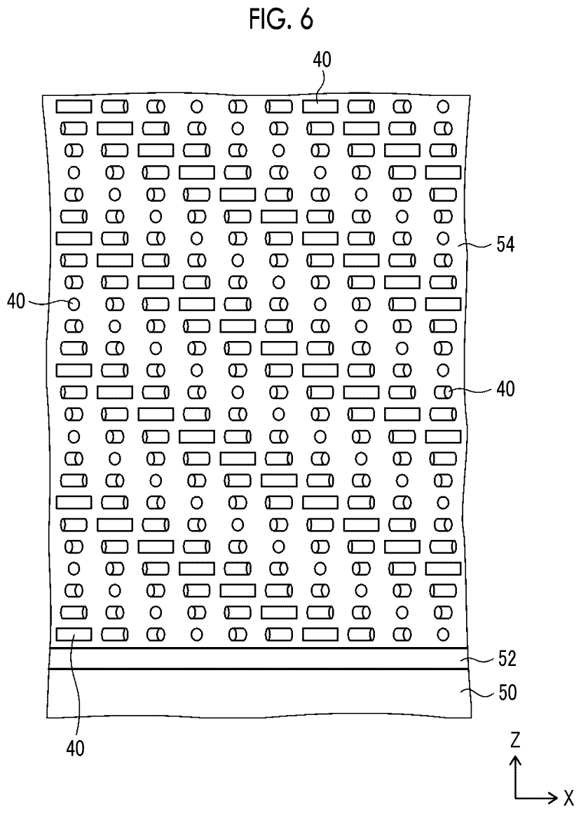

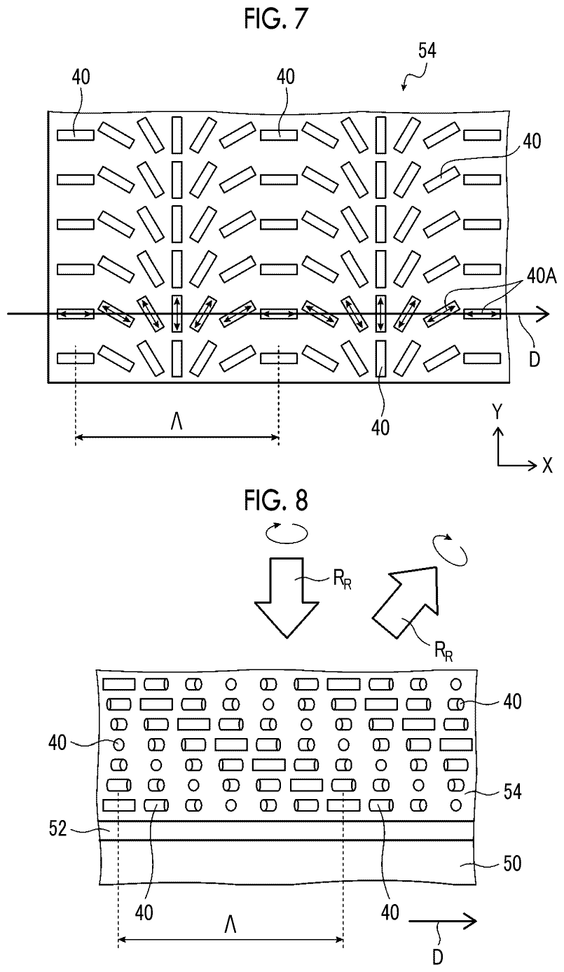

FIGS. 6 and 7 schematically show an example of the reflective type liquid crystal diffraction element.

As shown in FIG. 6, the reflective type liquid crystal diffraction element includes a support 50, an alignment film 52, and a cholesteric liquid crystal layer 54 that acts as the reflective type liquid crystal diffraction element.

FIG. 7 is a diagram schematically showing an orientation state of the liquid crystal compound in a plane of a main surface of the cholesteric liquid crystal layer 54.

In the following description, it is assumed that a main surface of the cholesteric liquid crystal layer 54 is an X-Y plane and a cross-section perpendicular to the X-Y plane is an X-Z plane.

As shown in FIG. 6, the cholesteric liquid crystal layer 54 is a layer obtained by cholesteric alignment of the liquid crystal compound. FIGS. 6 to 8 show examples in a case where the liquid crystal compound constituting the cholesteric liquid crystal layer 54 is a rod-like liquid crystal compound.

The reflective type liquid crystal diffraction element shown in FIG. 6 includes the support 50, the alignment film 52, and the cholesteric liquid crystal layer 54, but the present invention is not limited thereto. The reflective type liquid crystal diffraction element may include, for example, only the alignment film 52 and the cholesteric liquid crystal layer 54, or may include only the cholesteric liquid crystal layer 54.

The support 50 supports the alignment film 52 and the cholesteric liquid crystal layer 54, and may be configured with, for example, glass, various resin films, and the like.

The alignment film 52 is an alignment film for aligning the liquid crystal compound constituting the cholesteric liquid crystal layer 54 in a predetermined liquid crystal alignment pattern. As the alignment film 52, for example, a well-known alignment film used for aligning the liquid crystal compound, such as a photo-alignment film using a photo-alignment material, can be used.

As will be described later, in the liquid crystal diffraction element, the cholesteric liquid crystal layer 54 has a liquid crystal alignment pattern in which an orientation of an optical axis 40A (refer to FIG. 7) derived from the liquid crystal compound 40 changes while continuously rotating in one in-plane direction. Accordingly, the alignment film 52 is formed such that the cholesteric liquid crystal layer 54 can form the liquid crystal alignment pattern. In the following description, “the orientation of the optical axis 40A rotates” will also be simply referred to as “the optical axis 40A rotates”.

In the reflective type liquid crystal diffraction element, the cholesteric liquid crystal layer 54 is formed on a surface of the alignment film 52.

The liquid crystal layer 54 is a cholesteric liquid crystal layer that is obtained by immobilizing a cholesteric liquid crystalline phase and has a liquid crystal alignment pattern in which a direction of an optical axis derived from a liquid crystal compound changes while continuously rotating in at least one in-plane direction.

As conceptually shown in FIG. 6, the liquid crystal layer 54 has a helical structure in which the liquid crystal compound 40 is helically turned and laminated as in a cholesteric liquid crystal layer obtained by immobilizing a typical cholesteric liquid crystalline phase. In the helical structure, a configuration in which the liquid crystal compound 40 is helically rotated once (rotated by 360°) and laminated is set as one helical pitch (helical pitch P), and plural pitches of the helically turned liquid crystal compound 40 are laminated.

As is well known, the cholesteric liquid crystal phase exhibits selective reflectivity with respect to levorotatory or dextrorotatory circularly polarized light at a specific wavelength. Whether or not the reflected light is dextrorotatory circularly polarized light or levorotatory circularly polarized light is determined depending on a helically twisted direction (sense) of the cholesteric liquid crystalline phase. Regarding the selective reflection of the circular polarization by the cholesteric liquid crystalline phase, in a case where the helically twisted direction of the cholesteric liquid crystalline phase is right, dextrorotatory circularly polarized light is reflected, and in a case where the helically twisted direction of the cholesteric liquid crystalline phase is left, levorotatory circularly polarized light is reflected.

For example, in the cholesteric liquid crystal layer 54 that selectively reflects dextrorotatory circularly polarized light, the twisted direction of the helix of the cholesteric liquid crystalline phase is right.

In addition, as is well known, a selective reflection wavelength (selective reflection center wavelength) at which selective reflection is exhibited depends on the helical pitch P of the cholesteric liquid crystalline phase. In the cholesteric liquid crystal layer 54, as the helical pitch P increases, light having a longer wavelength is selectively reflected. Accordingly, the wavelength of light to be reflected (diffracted) by the liquid crystal diffraction element may be set by appropriately adjusting and setting the helical pitch P of the cholesteric liquid crystal layer 54, for example.

In addition, a half-width Δλ (nm) of a selective reflection wavelength range (circularly polarized light reflection wavelength range) where selective reflection is exhibited depends on Δn of the cholesteric liquid crystalline phase and the helical pitch P and satisfies a relationship of Δλ=Δn×P. Therefore, the width of the selective reflection wavelength range can be controlled by adjusting Δn.

As shown in FIG. 7, in the X-Y plane of the cholesteric liquid crystal layer 54, the liquid crystal compounds 40 are arranged along a plurality of arrangement axes D parallel to the X-Y plane. On each of the arrangement axes D, the orientation of the optical axis 40A of the liquid crystal compound 40 changes while continuously rotating in the one in-plane direction along the arrangement axis D. In the example shown in the drawing, the optical axis 40A rotates clockwise in the arrangement axis D.

In the liquid crystal diffraction element including the cholesteric liquid crystal layer 54, a direction of the arrangement axis D (X direction), that is, a direction in which the optical axis 40A of the liquid crystal compound 40 rotates in a plane of the cholesteric liquid crystal layer 54 is a periodic direction in a diffraction structure of the diffraction element.

In the reflective type liquid crystal diffraction element including the cholesteric liquid crystal layer 54, in the liquid crystal alignment pattern of the liquid crystal compound 40, a length (distance) over which the optical axis 40A rotates by 180° in the arrangement axis D direction in which the optical axis 40A changes while continuously rotating in a plane is a single period Λ (diffraction period (in-plane pitch)) in the diffraction structure of the diffraction element.

On the other hand, in the liquid crystal compound 40 forming the cholesteric liquid crystal layer 54, the orientations of the optical axes 40A are the same in a direction (Y direction in FIG. 4) orthogonal to the arrangement axis D direction, that is, the periodic direction.

In other words, in the liquid crystal compound 40 forming the cholesteric liquid crystal layer 54, the angles formed between the optical axes 40A of the liquid crystal compound 40 and the arrangement axis D (X direction) are the same in the Y direction.

As is well known, a typical cholesteric liquid crystal layer that does not have a liquid crystal alignment pattern specularly reflects incident ray. Accordingly, in a case where light is incident from the normal direction, the typical cholesteric liquid crystal layer reflects the light in the normal direction.

On the other hand, the cholesteric liquid crystal layer 54 having the above-described liquid crystal alignment pattern reflects incident ray in a state where the incident ray is tilted in the arrangement axis D direction (periodic direction) with respect to specular reflection. That is, the cholesteric liquid crystal layer 54 having the liquid crystal alignment pattern is a reflective type liquid crystal diffraction element.

Hereinafter, an action of diffraction by the cholesteric liquid crystal layer 54 will be described with reference to a schematic diagram of FIG. 8.

For example, the cholesteric liquid crystal layer 54 selectively reflects right circularly polarized light R_{R} of red light. Accordingly, in a case where light is incident into the cholesteric liquid crystal layer 54, the cholesteric liquid crystal layer 54 reflects only right circularly polarized light R_{R} of infrared light and allows transmission of the other light.

The cholesteric liquid crystal layer 54 has a liquid crystal alignment pattern in which the optical axis 40A of the liquid crystal compound 40 changes while rotating in the arrangement axis D direction, that is, the periodic direction.

The liquid crystal alignment pattern in the cholesteric liquid crystal layer 54 is a pattern that is periodic in the arrangement axis D direction. Therefore, as conceptually shown in FIG. 8, the right circularly polarized light R_{R} of the SWIR light incident into the cholesteric liquid crystal layer 54 is reflected (diffracted) in a direction corresponding to the period of the liquid crystal alignment pattern, and the reflected right circularly polarized light R_{R} of the SWIR light is reflected (diffracted) in a direction tilted in the arrangement axis D direction with respect to the XY plane (main surface of the cholesteric liquid crystal layer).

As a result, in a case where the cholesteric liquid crystal layer 54 is applied to the first diffraction element 201 and the first diffraction element 201A, the SWIR light included in the incident ray incident into the light guide substrate 101 from the normal direction can be reflected (diffracted) at an angle toward the second diffraction element 202, and the other light can be transmitted.

In the cholesteric liquid crystal layer 54, by appropriately setting the direction of the arrangement axis D as the one in-plane direction in which the optical axis 40A rotates, the reflection direction (diffraction direction) of light can be adjusted.

For example, in a case where circularly polarized light having the same wavelength and the same turning direction is reflected, by reversing the arrangement axis D direction as the periodic direction, a reflection direction of the circularly polarized light can be reversed. In other words, by setting the rotation direction of the optical axis 40A of the liquid crystal compound 40 toward the arrangement axis D direction, that is, the periodic direction to be counterclockwise, the reflection direction of circularly polarized light can be reversed.

Further, in the liquid crystal layer having the same liquid crystal alignment pattern, the reflection direction is reversed by adjusting the helical turning direction of the liquid crystal compound 40, that is, the turning direction of circularly polarized light to be reflected.

For example, in a case where the helical turning direction is right-twisted, the liquid crystal layer selectively reflects dextrorotatory circularly polarized light and has the liquid crystal alignment pattern in which the optical axis 40A rotates clockwise in the arrangement axis D direction. As a result, the dextrorotatory circularly polarized light is reflected in a state where it is tilted in the arrangement axis D direction.

In addition, for example, in a case where the helical turning direction is left-twisted, the liquid crystal layer selectively reflects levorotatory circularly polarized light, and has the liquid crystal alignment pattern in which the optical axis 40A rotates clockwise in the arrangement axis D direction. As a result, the levorotatory circularly polarized light is reflected in a state where it is tilted in a direction opposite to the arrangement axis D direction.

That is, in the cholesteric liquid crystal layer having the opposite revolution direction of the helix, the arrangement axis D direction is reversed, that is, the arrangement axis D direction is set to a direction different by 180°, so that light can be diffracted (reflected) in a state where the light is tilted in the same direction.

Accordingly, for example, by laminating the cholesteric liquid crystal layer 54 that selectively reflects SWIR light of dextrorotatory circularly polarized light and the cholesteric liquid crystal layer 54 that selectively reflects SWIR light of levorotatory circularly polarized light, which have the same liquid crystal alignment pattern, as shown in FIG. 3, the first diffraction element 201A that reflects the SWIR light included in the incident ray 401 into dextrorotatory circularly polarized light and levorotatory circularly polarized light in two different directions is obtained.

In this case, in the optical sensor system shown in FIG. 3, the SWIR light 403 diffracted and reflected in the right direction in the drawing by the first diffraction element 201A is dextrorotatory circularly polarized light, and the SWIR light 403 diffracted and reflected in the left direction in the drawing is levorotatory circularly polarized light. Alternatively, in this case, in the optical sensor system shown in FIG. 3, the SWIR light 403 diffracted and reflected in the right direction in the drawing by the first diffraction element 201A is levorotatory circularly polarized light, and the SWIR light 403 diffracted and reflected in the left direction in the drawing is dextrorotatory circularly polarized light.

In addition, by laminating the cholesteric liquid crystal layer 54 that selectively reflects SWIR light of dextrorotatory circularly polarized light and the cholesteric liquid crystal layer 54 that selectively reflects SWIR light of levorotatory circularly polarized light, which have the same liquid crystal alignment pattern except that the revolution directions of the liquid crystal compounds toward the arrangement axis D direction are opposite to each other, as shown in FIGS. 1 (FIG. 2) and 4, the first diffraction element 201 (diffraction element 203) and the second diffraction element 202 (diffraction element 204) that diffract and reflect incident ray in one direction regardless of polarization are obtained.

In a case where the first diffraction element 201 (diffraction element 203) and the second diffraction element 202 (diffraction element 204) are formed of one cholesteric liquid crystal layer, light to be selectively reflected by each diffraction element is any of dextrorotatory circularly polarized light or levorotatory circularly polarized light.

As described above, in the reflective type liquid crystal diffraction element, in the liquid crystal alignment pattern of the liquid crystal compound in the liquid crystal layer, the length over which the optical axis of the liquid crystal compound rotates by 180° is the single period Λ (diffraction period) in the periodic structure of the diffraction element.

In the cholesteric liquid crystal layer having the liquid crystal alignment pattern, as the single period Λ decreases, the diffraction increases. That is, as the single period Λ decreases, reflected light can be reflected in a state where it is largely tilted with respect to specular reflection of incident ray. In other words, as the diffraction period Λ decreases, an angle between the specular reflection direction and the reflected light increases.

Accordingly, by adjusting the single period Λ of the liquid crystal alignment pattern according to the diffraction angle required for the diffraction element, light can be diffracted and reflected in a desired direction.

In addition, in the cholesteric liquid crystal layer having the liquid crystal alignment pattern, the reflection angle (diffraction angle) of light varies depending on the wavelength of the light to be reflected. Specifically, as the wavelength of light increases, the angle of reflected light with respect to incident ray increases.

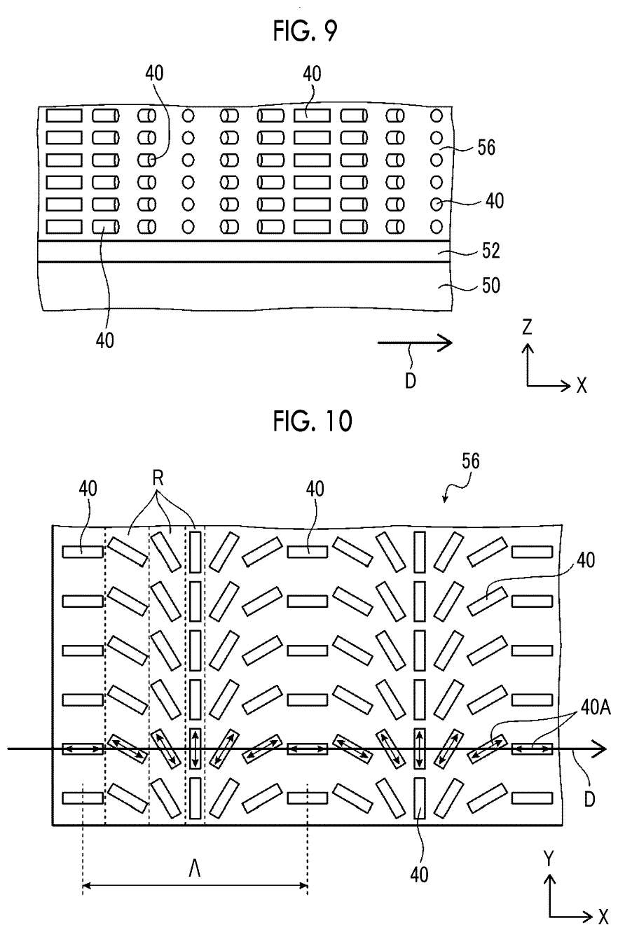

FIGS. 9 and 10 schematically show the transmissive type liquid crystal diffraction element.

A liquid crystal diffraction element shown in FIGS. 9 and 10 includes the support 50, the alignment film 52, and a liquid crystal layer 56. As the support 50 and the alignment film 52, those described above can be used.

As shown in FIG. 9, in the transmissive type liquid crystal diffraction element, the liquid crystal compound 40 forming the liquid crystal layer 56 is not helically twisted and rotated in the thickness direction, and the optical axes 40A are positioned at the same position in the plane direction.

As in the cholesteric liquid crystal layer 54, the liquid crystal layer 56 also has a liquid crystal alignment pattern in which the orientation of the optical axis 40A derived from the liquid crystal compound 40 changes while continuously rotating in the arrangement axis D direction, that is, the X direction in a plane. That is, in the liquid crystal layer 56 (transmissive type liquid crystal diffraction element), the period direction is the arrangement axis D direction (X direction). In addition, even in the liquid crystal layer 56, as shown in FIG. 10, the diffraction period Λ (the single period of the diffraction structure) is the length over which the optical axis 40A rotates by 180° in the arrangement axis D direction, that is, the periodic direction.

On the other hand, regarding the liquid crystal compound 40 forming the liquid crystal layer 56, the liquid crystal compounds 40 having the same direction of the optical axes 40A are arranged at regular intervals in the Y direction perpendicular to the X direction, that is, the Y direction perpendicular to the arrangement axis D (periodic direction) as the one in-plane direction in which the optical axis 40A continuously rotates.

In the liquid crystal layer 56, the liquid crystal compounds arranged in the Y direction have the same angle between the optical axis 40A and the X direction. Regions where the liquid crystal compounds 40 in which the angles between the optical axes 40A and the arrangement axis D are the same are disposed in the Y direction will be referred to as “regions R”.

In this case, it is preferable that the value of the in-plane retardation (Re) in each region R is a half wavelength, that is, λ/2.

In a case where circularly polarized light is incident into the liquid crystal layer 56, the transmitted light is diffracted (refracted) and the direction of the circularly polarized light is converted.

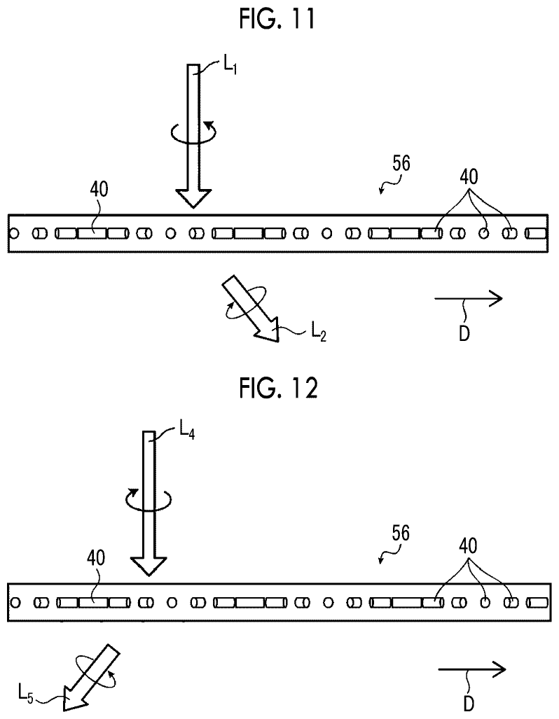

This action is conceptually shown in FIGS. 11 and 12. In the liquid crystal layer 56, the value of the product of the difference in refractive index of the liquid crystal compound and the thickness is λ/2.

As shown in FIG. 11, in a case where the value of the product of the difference in refractive index of the liquid crystal compound 40 in the liquid crystal layer 56 and the thickness is λ/2 and incident ray L₁ as levorotatory circularly polarized light is incident into the liquid crystal layer 56, the incident ray L₁ transmits through the liquid crystal layer 56 to be imparted with a retardation of 180°, and the transmitted light L₂ is converted into dextrorotatory circularly polarized light.

In addition, the liquid crystal alignment pattern formed in the liquid crystal layer 56 is a pattern that is periodic in the arrangement axis D direction. Therefore, the transmitted light L₂ travels in a direction different from a traveling direction of the incident ray L₁. In this way, the levorotatory circularly polarized incident rays L₁ are converted into dextrorotatory circularly polarized transmission rays L₂, which are tilted by a predetermined angle in the arrangement axis D direction with respect to an incidence direction.

On the other hand, as shown in FIG. 12, in a case where the value of the product of the difference in refractive index of the liquid crystal compound in the liquid crystal layer 56 and the thickness of the liquid crystal layer 56 is λ/2 and incident ray L₄ of dextrorotatory circularly polarized light is incident into the liquid crystal layer 56, the incident ray L₄ transmits through the liquid crystal layer 56 to be imparted with a retardation of 180°, and the incident light L₄ is converted into transmitted light L₅ of levorotatory circularly polarized light.

In addition, the liquid crystal alignment pattern formed in the liquid crystal layer 56 is a pattern that is periodic in the arrangement axis D direction. Therefore, the transmitted light L₅ travels in a direction different from a traveling direction of the incident ray L₄. In this case, the transmitted Light L₅ travels in a direction different from the transmitted light L₂, that is, in a direction opposite to the arrangement axis D direction with respect to the incidence direction. In this way, the incident ray L₄ is converted into the transmitted ray L₅ of the levorotatory circularly polarized light, which is tilted by a predetermined angle in a direction opposite to the arrangement axis D direction with respect to the incidence direction.

That is, the liquid crystal layer 56 is a transmissive type liquid crystal diffraction element.

As in the cholesteric liquid crystal layer 54, in the liquid crystal layer 56, by changing the single period Λ (diffraction period) of the formed liquid crystal alignment pattern, the diffraction angles of the transmitted light L₂ and the transmitted light L₅ can be adjusted. Specifically, in the liquid crystal layer 56, as the single period Λ of the liquid crystal alignment pattern decreases, the transmitted light L₂ and L₅ can be more largely diffracted. Accordingly, by adjusting the single period Λ according to the refraction angle of the transmitted light that is a target of the diffraction element, light in each wavelength range can be diffracted and transmitted in a desired direction.

In addition, by reversing the rotation direction of the optical axis 40A of the liquid crystal compound 40 that rotates in the arrangement axis D direction, that is, the periodic direction, the diffraction direction of transmitted light can be reversed. That is, in the example FIGS. 9 to 12, the rotation direction of the optical axis 40A toward the arrangement axis D direction, that is, the periodic direction is clockwise. By setting this rotation direction to be counterclockwise, the diffraction direction of transmitted light can be reversed.

In addition, in the liquid crystal layer 56 that functions as a transmissive type liquid crystal diffraction element, the longer the wavelength of light, the larger the diffraction (refraction).

Accordingly, as shown in FIG. 5, by using the transmissive type liquid crystal diffraction element as the first diffraction element 201B, for example, in a case where incident ray in which visible light and SWIR light are mixed is incident, the visible light and the SWIR light can be separated from each other by a difference in diffraction size. In addition, as described above, the visible light having a small diffraction angle by the first diffraction element 201B can be incident on the interface between the light guide substrate 101 and the air at an angle smaller than the Brewster angle and can be emitted from the light guide substrate 101. On the other hand, the SWIR light having a large diffraction angle by the first diffraction element 201B can be incident on the interface between the light guide substrate 101 and the air at an angle larger than the Brewster angle, and can be guided in the light guide substrate 101 by repeating total reflection.

The forms shown in FIGS. 1 to 5 represent a form in which the diffraction element is bonded to the light guide substrate, but the diffraction element does not necessarily need to be bonded.

For the bonding of the diffraction element, a known bonding agent such as optically clear adhesive (OCA) can be used as long as the light to be measured can be transmitted.

In the light guide substrate, light travels through the inside of the light guide substrate while being totally reflected due to a difference in refractive index between the material of the light guide substrate and air on both main surfaces of the front and back sides. In addition, it is desirable to suppress unintended interface reflection or the like due to a difference in refractive index between the substrate and the diffraction element. Accordingly, it is desirable that the light guide substrate has a refractive index in a range of 1.45 to 2.0.

As described above, various known light guide members such as a light guide plate used in a backlight unit of a liquid crystal display device can be used as the light guide substrate.

The material of the light guide substrate is suitably glass, acrylic, or polycarbonate, but is not limited thereto.

In addition, from the viewpoint of weight reduction and durability (breakage prevention), it is preferable that the thickness of the light guide substrate is 0.5 to 5.0 mm. Here, in a case where the diffraction element can diffract incident ray at a larger angle as in the liquid crystal diffraction element, even in a case where the thickness of the light guide substrate is reduced to 0.5 to 2.0 mm, the angle between the separated light components is large. Therefore, a plurality of sensors can be installed in parallel side by side.

As the sensor, various known sensors (photosensors) can be used as long as the sensor can perform photometry of light having a wavelength to be measured.

Examples of the sensor include a charge coupled device (CCD) sensor, a complementary metal-oxide-semiconductor (CMOS) sensor, an indium gallium arsenide (InGaAs) sensor, and a photodiode array.

The sensor may include a filter such as a band pass filter, a low-pass filter, and a high-pass filter that shields light in a wavelength range other than the light to be measured, as necessary.

Although representative embodiments of the present invention have been described above, the present invention is not limited to the above as long as it is within the scope of the claims, and various aspects that can be understood by those skilled in the art can be applied.

### EXPLANATION OF REFERENCES

40: liquid crystal compound
40A: optical axis
50: support
52: alignment film
54: cholesteric liquid crystal layer
56: liquid crystal layer
101: light guide substrate
201, 201A, 201B: first diffraction element
202: second diffraction element
203, 204: diffraction element
301: first sensor
302: second sensor
303: third sensor
401: incident ray
402: visible light
403: SWIR light
404: NIR light

What is claimed is:

1. An optical sensor system comprising at least:
a light guide substrate;
a diffraction element 1 that separates incident ray into rays of at least two wavelengths;
a diffraction element 2 that diffracts the rays separated by the diffraction element 1; and
a plurality of sensors that respectively sense a plurality of rays separated by the diffraction element 1.

2. The optical sensor system according to claim 1,
wherein the diffraction element 1 separates the incident ray into a ray of a wavelength in a visible light region and a ray of a wavelength in a short-wave infrared region.

3. The optical sensor system according to claim 1,
wherein the diffraction element 1 separates the incident ray into a ray of a wavelength in a visible light region, a ray of a wavelength in near-infrared light, and a ray of a wavelength in a short-wave infrared region.

4. The optical sensor system according to claim 1,
wherein either one of the diffraction element 1 and the diffraction element 2, or both of the diffraction element 1 and the diffraction element 2, are liquid crystal diffraction elements.

5. The optical sensor system according to claim 2,
wherein either one of the diffraction element 1 and the diffraction element 2, or both of the diffraction element 1 and the diffraction element 2, are liquid crystal diffraction elements.

6. The optical sensor system according to claim 3,
wherein either one of the diffraction element 1 and the diffraction element 2, or both of the diffraction element 1 and the diffraction element 2, are liquid crystal diffraction elements.
